(19) United States
(12) Patent Application Publication
(10) Pub. No.: US 2026/0036871 A1
(43) Pub. Date: Feb. 5, 2026

(54) METHOD FOR MANUFACTURING A PHOTON EMITTER

(71) Applicant: Universität Paderborn, Körperschaft des öffentlichen Rechts, Paderborn (DE)

(72) Inventors: Silia BABEL, Borchen (DE); Laura PADBERG, Brilon (DE); Christine Silberhorn, Paderborn (DE)

(21) Appl. No.: 19/285,966

(22) Filed: Jul. 30, 2025

(30) Foreign Application Priority Data
Jul. 31, 2024 (DE) 10 2024 121 775.8

(51) Int. Cl. G02F 1/365; G02F 1/355

(52) U.S. Cl. CPC G02F 1/365; G02F 1/3551

(57) ABSTRACT

The disclosure concerns a method for manufacturing a photon emitter for the emission of photons including at least one insulator layer, one thin film layer and at least one waveguide positioned in the thin film layer, with the following method steps: providing the insulator layer; providing the thin film layer including a predetermined thin film layer thickness; positioning of the thin film layer on the insulator layer, such that the thin film layer lies flat on the insulator layer; determining a waveguide width of the minimum of one waveguide in the thin film layer, wherein the waveguide width is selected according to the predetermined thin film layer thickness such that the photons exhibit a predetermined property; generating the minimum of one waveguide in the thin film layer, wherein the waveguide exhibits the specific waveguide width.

The present application is based upon and claims the right of priority to DE Patent Application No. 10 2024 121 775.8, filed Jul. 31, 2024, the disclosure of which is hereby incorporated by reference herein in its entirety for all purposes.

The disclosure concerns a method for manufacturing a photon emitter for the emission of photons comprising at least one insulator layer, one thin film layer and at least one waveguide positioned in the thin film layer.

Photon emitters, especially in thin-film lithium niobate or lithium niobate on an insulator (lithium niobate on insulator [LNOI]), are an element that is used in photonics for non-linear conversion processes, in particular in (quantum) optical applications, such as the production of the Second-Harmonic Generation (SHG) or Parametric Down-Conversion (PDC) processes. Light is guided into waveguides in the material, and by selecting the waveguide geometry, it is possible to influence the processes. These processes depend on the thickness of the thin film. Because of this dependence, these processes deviate strongly from the ideal, since the thin film thickness varies due to manufacturing conditions alone. The commercially available LNOI wafers, for example (e.g. by NANOLN), exhibit variations in the range of +−20 mm across wafers. Moreover, the thickness of the thin film is not a parameter that can be determined during production of the waveguide itself. Thus as precise as the production process may be, the variation in thickness of the thin film is down to the manufacturer.

In non-linear crystals, light conversion processes can take place. For example, in Parametric Fluorescence or Parametric Down-Conversion (PDC), a photon known as a pump photon splits into two lower-frequency photons known as the signal and idler photons. For this process, two conditions must be fulfilled. Firstly, the conservation of energy, which is fulfilled by the frequency of both lower-frequency photons together equalling the frequency of the pump photon.

Secondly, the conservation of momentum must be fulfilled. For this, the propagation constant of both lower-frequency photons together must equal the propagation constant of the pump photon. However, due to dispersion, in the majority of crystals this condition is not fulfilled for arbitrary wavelength combinations. To be able to ultimately fulfil this condition, an additional propagation vector can be added by way of periodic inversion of the crystal structure, also known as periodic poling. This propagation vector i.e. an additional propagation constant is defined by the period of the poling. The poling period depends on the propagation constants of the interacting waves and is dependent on the refractive index. A change in the refractive index leads to a change in the poling period or, if the poling period remains the same, to a different propagation wavelength combination. The properties of the generated photons result from the dispersion of the material.

Photon emitters can consist of a thin film with an insulator beneath it. Beneath this, in turn, a further layer can be positioned. In the thin film, the light is guided in waveguides. These waveguides are generated in the thin film and are characterised in particular by the thickness of the thin film, the depth, width and angle of the waveguide.

Due to the properties described above, the output spectrum depends heavily on the variation of the thin film thickness. The thin film thickness is not a parameter that can be changed during the production of photon emitters, since the quality of and irregularities in the thin film thickness are determined by the manufacturer of the wafers.

Conventionally, to compensate for these irregularities in the thin film thickness, the poling period is adjusted via the waveguide (chirped quasi-phase-matching [QPM]). This results in the disadvantage that for this, the poling periods have to be well designed in order to compensate for the irregularities in the thin film thickness. This is associated with considerable additional expenditure. Moreover, the poling period in particular has to be adjusted in the nm range, which is hard to control and hard to produce.

Alternatively, the optical processes can take place in a high-Q resonator. For this, however, resonators are always required. What is more, the resonator necessarily substantially influences the bandwidths, such that spectrally very broadband processes are not possible.

The emitters known from the state of the art do not yet allow for the compensation of the influence of the irregularities in the thin film thickness in straight waveguides or even in resonators with a constant poling period.

On this basis, it is the purpose of the disclosure to produce a photon emitter that makes it particularly easy to compensate for the irregularities in the thin film thickness.

This purpose is fulfilled by the subject of patent claim 1. Preferred embodiments can be found in the sub-claims.

Thus according to the disclosure, a method for manufacturing a photon emitter for the emission of photons comprising at least one insulator layer, one thin film layer and at least one waveguide positioned in the thin film layer is provided, with the following method steps:
providing the insulator layer;
providing the thin film layer comprising a predetermined thin film layer thickness;
positioning of the thin film layer on the insulator layer, such that the thin film layer lies flat on the insulator layer;
determining a waveguide width of the minimum of one waveguide in the thin film layer, wherein the waveguide width is selected according to the predetermined thin film layer thickness such that the photons exhibit a predetermined property;
generating the minimum of one waveguide in the thin film layer, wherein the waveguide exhibits the specific waveguide width.

Where a “predetermined thin film layer thickness” is referred to here, this means in particular a thin film layer thickness that is fixed and can no longer be modified. The thin film layer thickness is determined by the manufacturer and may not be constant. When using the thin film layer to manufacture the photon emitter, it is no longer possible to influence the thin film layer thickness. The thin film layer thickness is therefore prespecified i.e. predetermined.

Preferably, the thin film layer is positioned on the insulator layer such that the waveguide, once it is then generated, is free-standing. This means in particular that on the sides facing away from the thin film layer, the waveguide does not have any contact with the surrounding layers.

Where a “predetermined property” is referred to here, this means in particular that for the photons to be emitted, a specific property is envisaged, which is to be achieved by way of the selection of the waveguide width. The thin film layer thickness is predetermined, and by suitable selection of the waveguide thickness, the desired property of the photons can be achieved.

Here, “thin film” is understood to mean in particular a layer of a material that, in comparison to its length and width, exhibits a relatively low thickness, typically in the nanometre to micrometre range. These films are often produced with the help of procedures such as evaporation, sputtering, chemical vapour deposition, smart cut and wafer thinning. In addition, they enable the production of complex layer structures with customised optical properties.

It is therefore a relevant point of the disclosure that the waveguide generated in the thin film is dependent on the thin film layer thickness. The width of the waveguide is selected depending on the existing and predetermined thin film layer thickness. In the event that the thin film layer thickness is not constant across a certain length, the waveguide width will also be accordingly adjusted and may vary depending on the thin film layer thickness. The waveguide width varies depending on the especially non-constant thin film layer thickness.

The thin film layer thickness may exhibit local deviations. The waveguide width is adjusted according to the local deviation of the thin film layer thickness. This means that the width of the waveguide changes as a function of the thickness at each point along the length of the waveguide. The waveguide width is selected depending on the thin film layer thickness, wherein the thin film layer thickness is not constant over a certain length. This results in the ‘spatially resolved’ adjustment of the waveguide width. The photon emitters generated in this manner can offer considerable advantages in particular for the production of spectrally very broadband, and thus temporally very short photon pulses with spectral engineering.

According to a preferred further development of the disclosure, the predetermined property of the photons encompasses a propagation constant that describes the propagation of the photons. The propagation constant is a measure of how quickly a wave propagates in a medium and how strongly it is attenuated. It is dependent on the properties of the medium, such as its refractive index and absorption properties. For optical systems such as fibre optic cables, for example, the propagation constant can indicate how quickly light is propagated through the fibre optic cable and how strongly it is attenuated in the process. Thus with a suitable selection of the waveguide width and a constant poling period, the variation in the spectrum due to the thin film layer thickness is compensated for. Preferably, for this, the propagation constant is calculated as a function of the thin film layer thickness and the waveguide width for the desired process and the desired geometry. In this way, one obtains the propagation constant as a function of the geometry and of the existing variation i.e. irregularity of the thin film layer thickness, in order to thus adjust the waveguide width. By modifying or adjusting the waveguide width, the changes described above due to the variation i.e. irregularity of the thin film layer thickness, and thus variations in the spectrum, can be compensated for. As a result, the width of the waveguide is adjusted depending on the thin film layer thickness in order to obtain a specific propagation constant.

According to a preferred further development of the disclosure, the thicker the thin film layer thickness, the smaller the waveguide width selected. Depending on the specific constellation, alternatively, the waveguide width selected can preferably be larger the thinner the thin film layer thickness. It has been shown that the waveguide width and the thin film layer thickness are inversely proportional to one another to keep a desired optical spectrum at a constant level. Therefore, preferably, the thicker the thin film layer thickness, the smaller the waveguide width must be or vice versa in order to maintain the desired optical spectrum.

According to a preferred further development of the disclosure, the waveguide is created using an etching method. The etching of waveguides in a thin film layer is a process in the manufacture of optical components, in particular in photonics and integrated optics. To begin with, a substrate material for the insulator is selected. Following this, a thin layer of the selected material is applied to the substrate. This can be carried out using various techniques such as physical evaporation, chemical vapour deposition (CVD) or sputtering. A photoresist is applied to the thin film layer and then exposed to create a pattern that defines the progression of the waveguide. This pattern is created, for example, with the help of a photomask containing the desired design of the waveguide. After exposure, the unexposed layer of photoresist is removed and the etching begins. Etching is a process in which the unprotected areas of the thin film layer are selectively removed in order to create the desired waveguide pattern. There are various types of etching, including dry etching (plasma etching) and wet etching (chemical etching), depending on the requirements of the process and the material. After etching, the remaining photoresist is removed to reveal the finished waveguide pattern. Once the waveguide has been etched, further steps such as the application of coatings or integration with other optical components can be carried out, depending on the requirements of the application.

According to a preferred further development of the disclosure, the insulator layer comprises silicon dioxide, sapphire or air. Silicon dioxide (SiO2) offers multiple advantages, particularly in optical applications. For one thing, silicon dioxide is transparent in the visible and near-infrared range of the electromagnetic spectrum. This means that optical signals can propagate efficiently through the material without undergoing any significant absorption or dispersion. This is especially important for optical communication systems where low losses and precise signal transmission are necessary. Moreover, silicon dioxide can be separated on silicon substrates using established manufacturing techniques such as chemical vapour deposition (CVD) or thermal oxidation. As silicon is a widely used substrate material in the semiconductor industry, the use of silicon dioxide as an insulator enables easy integration with other silicon-based components, such as transistors, sensors or optical waveguides. Silicon dioxide is chemically stable and resistant to corrosion and chemical degradation. This makes it a reliable material for long-term applications in various environments. In comparison to other insulator materials, silicon dioxide has a relatively low dielectric constant. This leads to low capacitance in integrated circuits and enables a higher operating speed and lower performance losses. Due to its widespread use in the semiconductor industry, silicon dioxide is available on a large scale and can be produced cost-effectively. This contributes to the cost efficiency of optical components that use silicon dioxide as an insulator material.

According to a preferred further development of the disclosure, the thin film layer comprises lithium niobate, magnesium-doped lithium niobate or lithium tantalate. Due to its unique optical and electrical properties, lithium niobate (LiNbO3) is suitable as a thin film for various applications in photonics and optical communication. One advantage is its high optical non-linearity, which makes it incredibly useful for the realisation of optical modulators, switches and frequency converters. In addition, lithium niobate demonstrates the electro-optic effect, enabling the realisation of electrically controlled optical components. The high optical transmission across a broad spectral range, in particular in the visible and near-infrared range, makes it well suited for applications where high light transmission is required, such as in optical modulators for fibre optic communication. Furthermore, lithium niobate is piezoelectric, which enables the production of acoustic and optical components such as acoustic modulators and filters. In addition, the crystalline structure of lithium niobate enables the production of high-quality thin films with precise optical properties that can be applied to substrates using various techniques to manufacture customised optical components.

According to a preferred further development of the disclosure, the thin film layer comprises a thin film layer thickness of between 300 nm and 1000 nm. Preferably, the insulator layer comprises a thickness of between 1 μm and 3 μm.

According to a preferred further development of the disclosure, there is a linear dependence between the thin film layer thickness and the waveguide width. A linear dependence is understood to mean a mathematical relationship between two or more variables that can be depicted with a straight line. This type of relationship is described as linear because it behaves according to the principle of proportionality: a change in a variable leads to an (inversely) proportional change in one or several other variables.

The disclosure is further explained in detail below with reference to a preferred embodiment of the disclosure with reference to the drawings.

In the drawings,

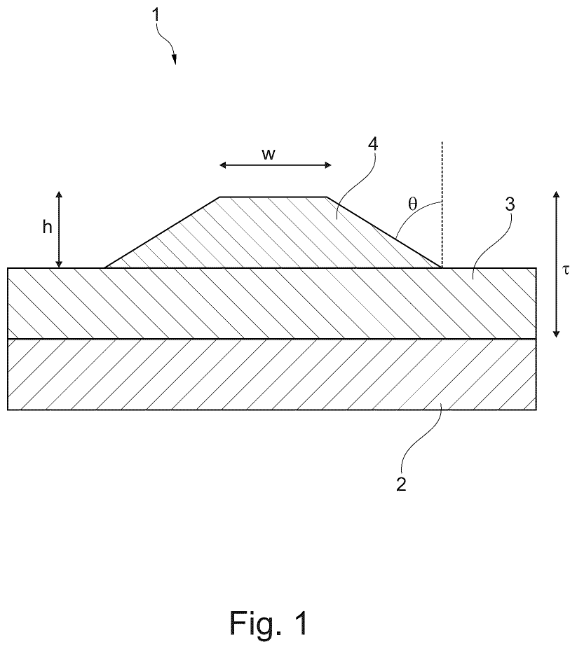

FIG. 1 shows a photon emitter in a schematic sectional view according to a preferred embodiment of the disclosure,

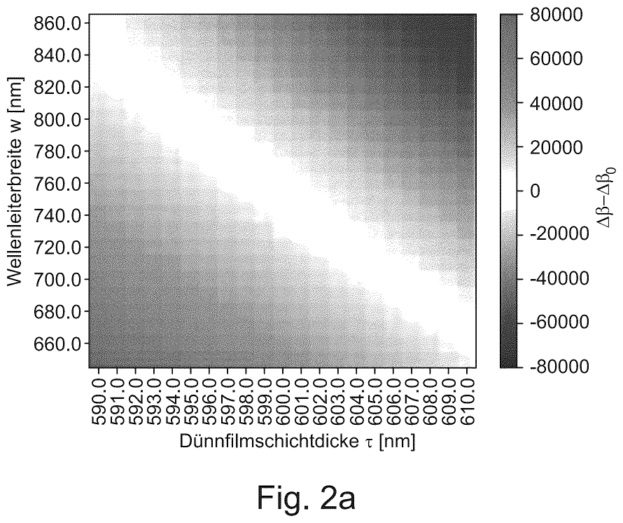

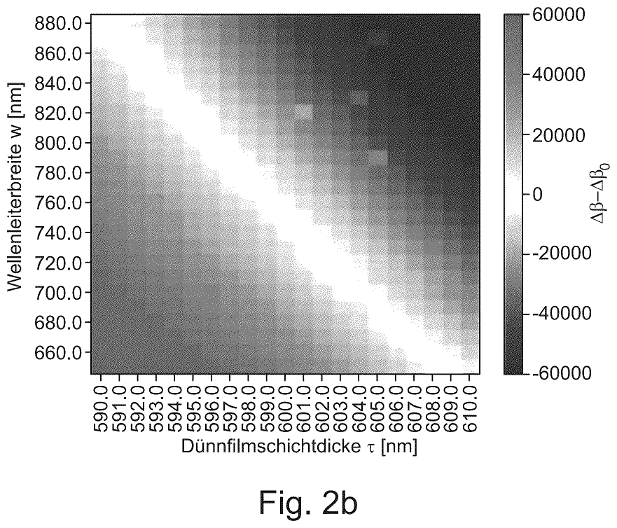

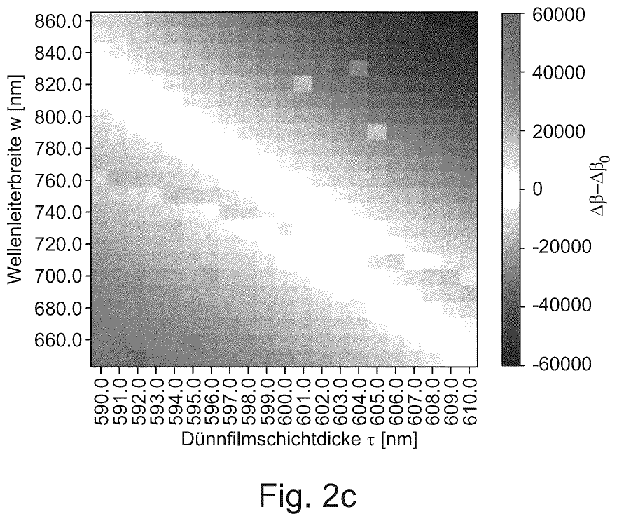

FIG. 2a-c each show a linear relationship between the thin film layer thickness and the waveguide width according to a preferred embodiment of the disclosure,

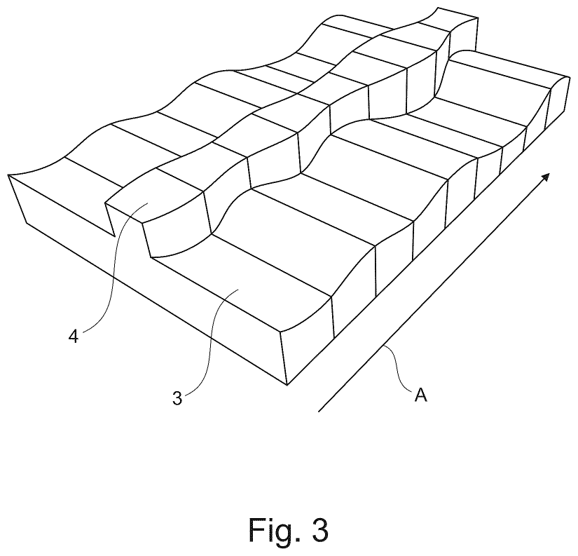

FIG. 3 shows the relationship between the thin film layer thickness and the waveguide width.

FIG. 1 shows a schematic depiction of a photon emitter 1. The photon emitter 1 comprises an insulator layer 2 and a thin film layer 3 applied to this. On the thin film layer 3, a further insulator layer can preferably be positioned in conclusion. However, this is not shown. In the photon emitter 1, the light is guided in waveguides 4. These waveguides 4 are usually created by etching the thin film layer 3. The waveguides are characterised by the thin film layer thickness τ, the etching depth h, the waveguide width w and the angle of the waveguide θ.

With an existing geometry, a variation in the thin film layer thickness τ of just 5 nm would lead to a change in the propagation constant i.e. the wavelength of a photon to be emitted. The appropriate modification of the waveguide width w makes it possible to compensate for the thin film variation. The relationship between the waveguide width w and the thin film layer thickness τ is shown in FIGS. 2a to 2c. In each, the thin film layer thickness τ is depicted on the x-axis, against the waveguide width w on the y-axis. The scale shows the deviation from the desired propagation constants of the ideal structure. White boxes show that there is no deviation. FIG. 2a shows the relationship between the waveguide width w and the thin film layer thickness τ of a type II process. FIG. 2b shows the relationship between the waveguide width w and the thin film layer thickness τ of a type I process. FIG. 2c shows the relationship between the waveguide width w and the thin film layer thickness τ of a type 0 process. For non-linear processes with lithium niobate on insulator (LNOI) waveguides, the terms “type II process”, “type I process” and “type 0 process” refer to different configurations of the optical polarisations of the pump, signal and idler beams. Type II describes a process in which two orthogonal polarisations for the signal and idler beams are present; with type I, the polarisations of the signal and idler photons are the same, but the pump beam polarisation is orthogonal, whereas in type 0 processes, the polarisations of all light beams are parallel to one another.

In FIG. 2a (type II process), it can be observed that as the thin film layer thickness τ becomes thicker, the waveguide width w must be made narrower, and for thinner thin film layer thicknesses τ, the waveguide width must be made wider. This results in linear behaviour between the waveguide width w and the thin film layer thickness τ. The linear relationship shows that with a linearly decreasing or increasing thin film 3, the width of the waveguide 4 can easily be adjusted linearly.

Even for a process with different wavelengths, compensation is possible. FIG. 2b displays the relationship of the waveguide width w to the thin film layer thickness τ in a type I process. In this example, 532 nm is used as the pump wavelength and photons with a wavelength of 810 nm and 1550 nm are generated. It can be observed that as the thin film layer thickness τ becomes thicker, the waveguide width w must be made narrower, and for thinner thin film layer thicknesses τ, the waveguide width must be made wider. This results in linear behaviour between the waveguide width w and the thin film layer thickness τ. The linear relationship shows that with a linearly decreasing or increasing thin film 3, the width of the waveguide 4 can easily be adjusted linearly.

FIG. 2c shows the relationship of the waveguide width w to the thin film layer thickness τ in a type 0 process with the same wavelengths from FIG. 2b. Linear behaviour between the waveguide width w and the thin film layer thickness τ is apparent. The linear relationship shows that with a linearly decreasing or increasing thin film 3, the width of the waveguide 4 can easily be adjusted linearly.

FIG. 3 schematically shows the relationship between the non-constant thin film layer thickness and the spatially resolved waveguide width. The thickness of the thin film layer 3 varies along the length A and is therefore not constant. The width of the waveguide 4 changes depending on the thickness of the thin film layer. The waveguide 4 width therefore also varies along the length in the direction of the arrow depending on the thickness of the thin film layer. The waveguide width varies depending on the non-constant thin film layer thickness. The thin film layer thickness is not constant and exhibits local deviations. The waveguide width is adjusted according to the local deviation of the thin film layer thickness. This means that the width of the waveguide 4 changes depending on the thickness at each point along the length of the waveguide 4. The waveguide width is selected depending on the thin film layer thickness, wherein the thin film layer thickness is not constant over a certain length. This results in the ‘spatially resolved’ adjustment of the waveguide width.

### LIST OF REFERENCES

1 Photon emitter
2 Insulator layer
3 Thin film layer
4 Waveguide
h Etching depth
W Waveguide width
τ Thin film layer thickness
θ Waveguide angle
A length

1. A method for manufacturing a photon emitter for emitting photons comprising at least one insulator layer, one thin film layer and at least one waveguide positioned in the thin film layer, with the following method steps:
providing the insulator layer;
providing the thin film layer comprising a predetermined thin film layer thickness;
positioning of the thin film layer on the insulator layer, such that the thin film layer lies flat on the insulator layer and/or such that the waveguide is free-standing;
determining a waveguide width of the minimum of one waveguide in the thin film layer, wherein the waveguide width is selected according to the predetermined thin film layer thickness such that the photons exhibit a predetermined property; and
generating the minimum of one waveguide in the thin film layer, wherein the waveguide exhibits the specific waveguide width.

2. The method according to claim 1, wherein the predetermined property of the photons encompasses a propagation constant that describes the propagation of the photons.

3. The method according to claim 1, wherein the thicker the thin film layer thickness, the smaller the waveguide width selected.

4. The method according to claim 1, wherein the waveguide is generated using an etching method.

5. The method according to claim 1, wherein the insulator layer comprises silicon dioxide, sapphire, or air.

6. The method according to claim 1, wherein the thin film layer comprises lithium niobate, magnesium-doped lithium niobate, or lithium tantalate.

7. The method according to claim 1, wherein the thin film layer comprises a thin film layer thickness of between 300 nm and 1000 nm.

8. The method according to claim 1, wherein the insulator layer comprises a thickness of between 1 μm and 3 μm.

9. The method according to claim 1, wherein a linear dependence is between the thin film layer thickness and the waveguide width.
